(19) United States
(12) Patent Application Publication
(10) Pub. No.: US 2025/0348324 A1
(43) Pub. Date: Nov. 13, 2025

(54) PREDICTION OF STARTUP PERFORMANCE OF COMMUNICATION DEVICE

(71) Applicant: Nokia Technologies Oy, Espoo (FI)

(72) Inventor: Rongbin LI, Espoo (FI)

(21) Appl. No.: 18/867,272

(22) PCT Filed: May 27, 2022
(86) PCT No.: PCT/CN2022/095565

§ 371 Date: Nov. 19, 2024

(51) Int. Cl. G06F 9/4401

(52) U.S. Cl. CPC G06F 9/4401

(57) ABSTRACT

Embodiments of the present disclosure relate to prediction of startup performance of communication device. In one aspect, an electronic device may obtain a set of configurations of a communication device and a set of test values of startup performance of the communication device for the set of configurations, and construct a model for startup performance predication by using a configuration in the set of configurations as an input and a corresponding test result in the set of test values as an output. In another aspect, an electronic device may obtain a configuration of a communication device to be tested; and determine a predicted value of startup performance of the communication device by using the configuration as an input of the model. In this way, predication of startup performance for different configurations may be achieved based on limited test results.

### FIELD

Embodiments of the present disclosure generally relate to the field of telecommunication and in particular, to a method, device, apparatus and computer readable storage medium for predicting startup performance of a communication device.

### BACKGROUND

System startup performance (e.g., startup time) depends on many factors including different hardware (HW) combination, software (SW) version, SW configuration, SW feature ON/OFF, etc. Customer requires almost same startup performance target for a communication device or product. That is, each configuration of the communication device should follow the startup performance target required by the customer. However, a communication device has up to thousands of configurations, and customers expect that all these configurations should match the startup performance target. Thus, it will be a huge work to test startup performance for so many configurations of a communication device.

### SUMMARY

In general, example embodiments of the present disclosure provide a solution for predicting startup performance of a communication device.

In a first aspect, there is provided an electronic device. The electronic device comprises at least one processor; and at least one memory including computer program code; the at least one memory and the computer program code are configured to, with the at least one processor, cause the electronic device to: obtain a set of configurations of a communication device and a set of test values of startup performance of the communication device for the set of configurations; and construct a model for startup performance predication by using a configuration in the set of configurations as an input and a corresponding test result in the set of test values as an output.

In a second aspect, there is provided an electronic device. The electronic device comprises at least one processor; and at least one memory including computer program code; the at least one memory and the computer program code are configured to, with the at least one processor, cause the electronic device to: obtain a configuration of a communication device to be tested; and determine a predicted value of startup performance of the communication device by using the configuration as an input of a model for startup performance predication.

In a third aspect, there is provided a method for communication. The method comprises: obtaining, at an electronic device, a set of configurations of the communication device and a set of test values of the startup performance of the communication device for the set of configurations; and constructing a model for startup performance predication by using a configuration in the set of configurations as an input and a corresponding test result in the set of test values as an output.

In a fourth aspect, there is provided a method for communication. The method comprises: obtaining, at an electronic device, a configuration of the communication device to be tested; and determining a predicted value of startup performance of the communication device by using the configuration as an input of a model for startup performance predication.

In a fifth aspect, there is provided an apparatus for communication. The apparatus comprises: means for obtaining, at an electronic device, a set of configurations of the communication device and a set of test values of the startup performance of the communication device for the set of configurations; and means for constructing a model for startup performance predication by using a configuration in the set of configurations as an input and a corresponding test result in the set of test values as an output.

In a sixth aspect, there is provided an apparatus for communication. The apparatus comprises: means for obtaining, at an electronic device, a configuration of the communication device to be tested; and means for determining a predicted value of startup performance of the communication device by using the configuration as an input of a model for startup performance predication.

In a seventh aspect, there is provided a non-transitory computer readable medium comprising program instructions for causing an apparatus to perform the method according to the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which embodiments of the present disclosure may be implemented;

FIG. 2 illustrates a flowchart of an example method implemented at an electronic device according to some embodiments of the present disclosure;

FIG. 3 illustrates a flowchart of another example method implemented at an electronic device according to some embodiments of the present disclosure; and

FIG. 4 illustrates a simplified block diagram of an electronic device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication device” refers to a device used in a communication network. The term “communication network” refers to a network following any suitable communication standards, such as Long Term Evolution (LTE), LTE-Advanced (LTE-A), Wideband Code Division Multiple Access (WCDMA), New Radio (NR) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

In some embodiments, the term “communication device” may refer to a network device. The term “network device” may refer to a node in a communication network via which a terminal device accesses the network and receives services therefrom. The communication network may be a radio access network (RAN). The network device in RAN may refer to a base station (BS) or an access point (AP), for example, a node B (NodeB or NB), an evolved NodeB (eNodeB or eNB), a NR next generation NodeB (also referred to as a gNB), a Remote Radio Unit (RRU), a radio header (RH), a remote radio head (RRH), a relay, a low power node such as a femto, a pico, and so forth, depending on the applied terminology and technology. An radio access network (RAN) split architecture comprises a gNB-CU (centralized unit, hosting radio resource control (RRC), service data adaptation protocol (SDAP) and packet data convergence protocol (PDCP) layers) controlling a plurality of gNB-DUs (distributed unit, hosting radio link control (RLC), medium access control (MAC) and physical (PHY) layers).

Alternatively, the communication network may be a core network (CN). The network device in CN may refer to a policy control function (PCF), an access management function (AMF), a session management function (SMF), a user plane function (UPF), unified data management (UDM), unified data repository (UDR), an authentication server function (AUSF), a ProSe key management function (PKMF), a direct discovery name management function (DDNMF), a network exposure function (NEF), etc.

In some embodiments, the term “communication device” may refer to a terminal device. The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

As mentioned above, a communication device has up to thousands of configurations, and customers expect that all these configurations should match startup performance target. Each configuration may have different HW combination and/or SW configurations. For each configuration, startup performance will fluctuate from release to release, and even in single release, startup performance will also fluctuate in different test iterations. It will be a huge work to test so many combinations of one single release.

A conventional test or verification method is to choose several typical configurations and test startup performance of the typical configurations. For each typical configuration, lots of test iterations may be executed and an average value of these test iterations may be used to compare with startup performance target.

Since there are so many configuration combinations for a communication device, it is impossible to test every combination to determine whether the combination match the startup performance target because this will cost many test time and test environments. Thus, only a few configurations are tested and test coverage of each release is very low.

For other untested configurations, it is assumed that they will have similar result. To avoid test found issue, there will be a loosen startup performance target for the untested configurations. This will make communication products with the untested configurations uncompetitive.

In view of this, embodiments of the present disclosure provide a solution for predicting startup performance of a communication device. In the solution, a machine learning (ML) method is applied to construct a model for startup performance prediction based on a set of test results for a set of configurations and use the model to predict startup performance for an untested configuration of a communication device.

In this way, predication of startup performance for different configurations may be achieved based on limited test results. It is helpful to verify startup performance of each combination for a release. Further, it is helpful to converge startup performance target and have a performance overview of all configurations. Then advantage actions may be done before a configuration with bad performance release is provided to customer.

In addition, with the ML method, startup performance for all configurations may be predicted and it is unnecessary to “guess” startup performance for an untested configuration. In this way, a lot of time to test or manually analyze an untested configuration may be saved. Based on history test results, startup performance for a configuration may be accurately given, even if the configuration has not been tested before.

Principles and implementations of the present disclosure will be described in detail below with reference to the figures.

### Example of Application Environment

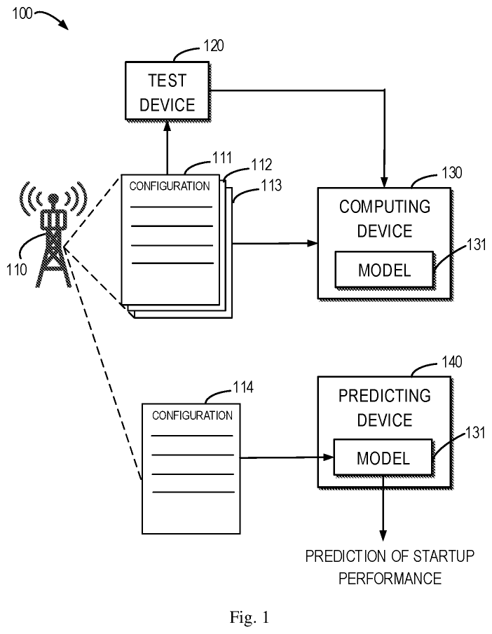

FIG. 1 illustrates a schematic diagram of an example environment 100 in which embodiments of the present disclosure can be implemented. As shown in FIG. 1, the environment 100 may involve a communication device 110, a test device 120, a computing device 130 and a predicting device 140.

As shown in FIG. 1, the communication device 110 may have configurations 111, 112 and 113. Each configuration may comprise different HW components, SW configurations and/or topology structures. The test device 120 may test startup performance for each configuration in the configurations 111, 112 and 113. In this way, test results corresponding to the configurations may be obtained.

Based on the configurations 111, 112 and 113 and the corresponding test results, the computing device 130 may construct a model 131 based on a ML method. It is to be understood that the ML method may be any suitable ML algorithms existing or to be developed in future, and the present disclosure does not limit this aspect. It is also to be understood that the computing device 130 may be an electronic device that supports model construction, such as computer, a computing cluster, etc., In some embodiments, the electronic device may be a terminal device. In some embodiments, the electronic device may be a network device.

As shown in FIG. 1, the predicting device 140 may use the model 131 to predict startup performance for an untested configuration 114 of the communication device 110. It is to be understood that the predicting device 140 may be an electronic device that supports model use, such as computer, a computing cluster, etc. In some embodiments, the electronic device may be a terminal device. In some embodiments, the electronic device may be a network device. It is also to be understood that although the computing device 130 and the predicting device 140 are shown as separate devices, the computing device 130 and the predicting device 140 may be the same device.

In some embodiments, the communication device 110 may be an access network device. In some embodiments, the communication device 110 may be a core network device. In some embodiments, the communication device 110 may be a terminal device.

In this example, the communication device 110 is illustrated as a base station. Alternatively, the communication device 110 may be a cloud base station. As another example, the communication device 110 may be a base transceiver station (BTS). It should be noted that these are merely examples, and the communication device 110 may be any other suitable types of network devices or terminal devices.

Further, it is to be understood that the number of devices and configurations is only for the purpose of illustration without suggesting any limitations. The environment 100 may include any suitable number or type of devices and configurations adapted for implementing embodiments of the present disclosure.

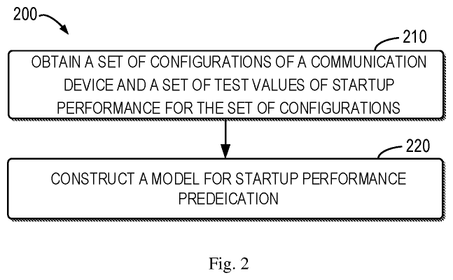

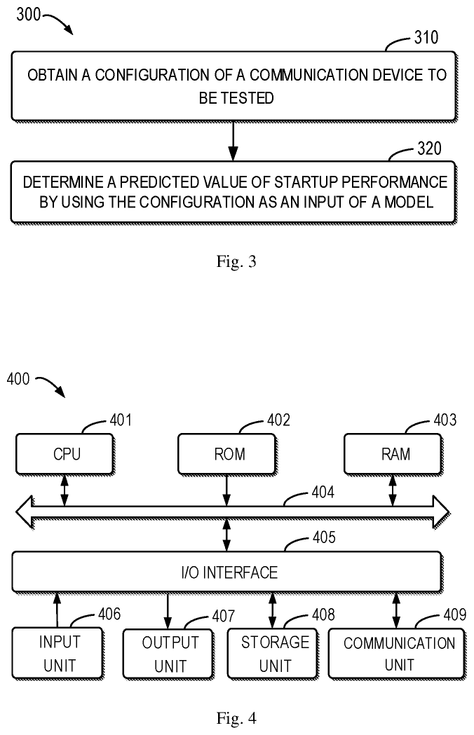

For illustration, some example embodiments of model construction and use for startup performance prediction will be described below in connection with FIGS. 2 and 3.

### Example Implementation of Model Construction

FIG. 2 illustrates a flowchart of an example method 200 implemented at an electronic device (for example, the computing device 130) according to some embodiments of the present disclosure. For the purpose of discussion, the method 200 will be described with reference to FIG. 1.

At block 210, the computing device 130 obtains a set of configurations of the communication device 110 and a set of test values of startup performance of the communication device 110 for the set of configurations. In other words, the computing device 130 may obtain a learning set for model construction.

In some embodiments, the computing device 130 may obtain, from the test device 120, the set of configurations and the set of test values of startup performance. In some embodiments, the set of configurations and the corresponding set of test values of startup performance are stored in a storage (not shown) and the computing device 130 may obtain, from the storage, the set of configurations and the corresponding set of test values of startup performance. In some embodiments, the storage may be a local storage. In some embodiments, the storage may be a cloud storage. It is to be noted that the storage may adopt any other suitable forms, and the computing device 130 may obtain the set of configurations and the corresponding set of test values of startup performance in any other suitable ways.

At block 220, the computing device 130 constructs a model for startup performance predication by using a configuration in the set of configurations as an input and a corresponding test result in the set of test values as an output. The computing device 130 may construct the model by any suitable ML algorithms existing or to be developed in future.

In some embodiments, each configuration in the set of configurations may comprise a set of factors associated with the startup performance of the communication device 110. In some embodiments, the set of factors in the configuration may comprise at least one of hardware, software or topology for a component in the communication device 110. In some embodiments, the component may comprise a baseband unit (BBU) or a baseband processing unit. In some embodiments, the component may comprise a radio unit (RU) or a radio processing unit or an antenna unit. It is to be understood that these are merely examples, and the set of factors may also involve any other suitable components of the communication device 110.

In some embodiments, the set of factors may comprise the number or types of hardware in a BBU. For example, the set of factors may comprise the number or types of system boards, capacity boards or common boards comprising system and capacity boards. It is to be understood that this is merely an example, and any other suitable hardware is also feasible.

In some embodiments, the set of factors may comprise the number or types of software in a BBU. For example, the set of factors may comprise the number or types of cloud system board functions, cloud capacity board functions or cloud common board functions comprising system and capacity board functions. It is to be understood that this is merely an example, and any other suitable software is also feasible.

In some embodiments, the set of factors may comprise the number or types of hardware in a RU. For example, the set of factors may comprise the number or types of antennas. It is to be understood that this is merely an example, and any other suitable hardware is also feasible.

In some embodiments, the set of factors may comprise the number or types of software in a RU. For example, the set of factors may comprise the number or types of antenna technologies. As another example, the set of factors may comprise the number or types of antenna protocols. It is to be understood that these are merely examples, and any other suitable software is also feasible.

In some embodiments, the set of factors may comprise the number of radio access technologies (RATs). In some embodiments, the set of factors may comprise the number of cells. It is to be understood that these are merely examples, and any other suitable topologies are also feasible. It is also to be understood that the set of factors may comprise any combination of the above or any other suitable information.

With ML model, the computing device 130 may determine a set of parameters associated with the set of factors. In other words, the computing device 130 may determine a weight for each factor.

For example, configurations 1 to 9 may be obtained as shown in Table 1. Each row represents a configuration that has different factors, and each row will have a test result (not shown). In this example, considered factors comprise the number of type A BBU-system boards, the number of type B BBU-system boards, the number of type A BBU-common boards, the number of type B BBU-common boards, the number of type A BBU-capacity boards, the number of type B BBU-capacity boards, the cell number of 5G RAT X, the cell number of 5G RAT Y, the number of type A RUs and the number of type B RUs.

TABLE 1

| | Number | Number | Number | Number | Number | Number | 5G | 5G | | |
|---|---|---|---|---|---|---|---|---|---|---|
| | of type | of type | of type | of type | of type | of type | RA | RAT | Number | Number |
| | A BBU- | B BBU- | A BBU- | B BBU- | A BBU- | B BBU- | TX | Y | of | of |
| Configuration | system | system | common | common | capacity | capacity | Cell | Cell | type | type |
| No. | board | board | board | board | board | board | number | number | A RU | B RU |
| 1 | 0 | 0 | 1 | 1 | 0 | 0 | 0 | 0 | 2 | 0 |
| 2 | 0 | 0 | 1 | 0 | 0 | 0 | 1 | 0 | 0 | 1 |
| 3 | 0 | 0 | 1 | 1 | 0 | 0 | 3 | 0 | 0 | 0 |
| 4 | 0 | 0 | 2 | 4 | 0 | 0 | 0 | 0 | 0 | 0 |
| 5 | 0 | 0 | 2 | 4 | 0 | 0 | 0 | 4 | 0 | 0 |
| 6 | 1 | 0 | 0 | 3 | 0 | 0 | 0 | 0 | 0 | 0 |
| 7 | 1 | 0 | 1 | 1 | 0 | 0 | 0 | 0 | 0 | 0 |
| 8 | 0 | 1 | 1 | 0 | 1 | 1 | 1 | 1 | 0 | 0 |
| 9 | 0 | 0 | 1 | 0 | 3 | 0 | 0 | 0 | 0 | 0 |

For the set of configurations as shown in Table 1, the computing device 130 may use normal equation as shown in equation (1) below to calculate a parameter or weight for each factor.

$$θ = {( {X}^{T} X )}^{- 1} {X}^{T} Y \qquad ( 1 )$$

where θ denotes a parameter for a factor, X denotes a matrix of factors in configurations, and Y denotes a matrix of test values of startup performance. It is to be understood that the equation (1) is merely an example, and the computing device 130 may calculate a parameter for each factor by any other suitable ways.

For example, a set of parameters associated with the set of factors may be obtained as shown in Table 2. It is to be understood that Table 2 is merely for illustration and is not intended for limitation.

TABLE 2

| Number | Number | Number | Number | Number | Number | 5G | 5G | | |
|---|---|---|---|---|---|---|---|---|---|
| of type | of type | of type | of type | of type | of type | RAT | RAT | Number | Number |
| A BBU- | B BBU- | A BBU- | B BBU- | A BBU- | B BBU- | X | Y | of | of |
| system | system | common | common | capcity | capacity | Cell | Cell | type | type |
| board | board | board | board | board | board | number | number | A RU | B RU |
| 96.7766 | 9.12808 | 81.7337 | 84.5405 | 11.8726 | 64.5342 | 81.7337 | −0.5 | 3.2265 | 19.8082 |

So far, a model for startup performance prediction may be constructed.

In some embodiments, the computing device 130 may obtain a further set of configurations of the communication device 110 and a further set of test values of startup performance of the communication device 110 for the further set of configurations, and update the model by using a configuration in the further set of configurations as an input and a corresponding test result in the further set of test values as an output.

In this way, the set of parameters may be updated based on the latest test results or learning sets. By training the model based on more factors in configurations and more test results, higher accuracy of the model may be attained.

### Example Implementation of Startup Performance Prediction

FIG. 3 illustrates a flowchart of an example method 300 implemented at an electronic device (for example, the predicting device 140) according to some embodiments of the present disclosure. For the purpose of discussion, the method 300 will be described with reference to FIG. 1.

At block 310, the predicting device 140 obtains a configuration of the communication device 110 that is to be tested or untested.

In some embodiments, the configuration may comprise a set of factors associated with the startup performance of the communication device 110. In some embodiments, the set of factors in the configuration may comprise at least one of hardware, software or topology for a component in the communication device 110.

In some embodiments, the component may comprise a BBU or a baseband processing unit. In some embodiments, the component may comprise a RU or a radio processing unit or an antenna unit. It is to be understood that these are merely examples, and the set of factors may also involve any other suitable components of the communication device 110.

In some embodiments, the set of factors may comprise the number or types of hardware in a BBU. For example, the set of factors may comprise the number or types of system boards, capacity boards or common boards comprising system and capacity boards. It is to be understood that this is merely an example, and any other suitable hardware is also feasible.

In some embodiments, the set of factors may comprise the number or types of software in a BBU. For example, the set of factors may comprise the number or types of cloud system board functions, cloud capacity board functions or cloud common board functions comprising system and capacity board functions. It is to be understood that this is merely an example, and any other suitable software is also feasible.

In some embodiments, the set of factors may comprise the number or types of hardware in a RU. For example, the set of factors may comprise the number or types of antennas. It is to be understood that this is merely an example, and any other suitable hardware is also feasible.

In some embodiments, the set of factors may comprise the number or types of software in a RU. For example, the set of factors may comprise the number or types of antenna technologies. As another example, the set of factors may comprise the number or types of antenna protocols. It is to be understood that these are merely examples, and any other suitable software is also feasible.

In some embodiments, the set of factors may comprise the number of RATs. In some embodiments, the set of factors may comprise the number of cells. It is to be understood that these are merely examples, and any other suitable topologies are also feasible. It is also to be understood that the set of factors may comprise any combination of the above or any other suitable information.

At block 320, the predicting device 140 determines a predicted value of startup performance of the communication device by using the configuration as an input of a model for startup performance predication. That is, a trained set of parameters is applied to the set of factors in the configuration and then a predicted value of startup performance for the configuration may be obtained. In this way, startup performance for an untested configuration of the communication device 110 may be predicted.

In some embodiments, the predicting device 140 may obtain a test value of the startup performance of the communication device 110 for the configuration. The predicting device 140 may determine a deviation between the test value and the predicted value. In some embodiments, based on comparison between the deviation and a threshold deviation, the predicting device 140 may determine availability of the configuration of the communication device 110. In some embodiments, based on comparison between the deviation and a threshold deviation, the predicting device 140 may determine availability of the model. In other words, the predicting device 140 may check the availability of the configuration of the communication device 110 or the availability of the model.

For example, an untested configuration 10 is obtained as shown in Table 3.

TABLE 3

| | Number | Number | Number | Number | Number | Number | 5G | 5G | | |
|---|---|---|---|---|---|---|---|---|---|---|
| | of type | of type | of type | of type | of type | of type | RAT | RAT | Number | Number |
| | A BBU- | B BBU- | A BBU- | B BBU- | A BBU- | B BBU- | X | Y | of | of |
| Configuration | system | system | common | common | capacity | capacity | Cell | Cell | type | type |
| No. | board | board | board | board | board | board | number | number | A RU | B RU |
| 10 | 0 | 1 | 0 | 0 | 3 | 3 | 0 | 1 | 0 | 2 |

The predicting device 140 may predict startup performance for the configuration. A test value of the startup performance for the configuration may also be obtained from the test device 120. Table 4 shows the predicted value and the test value of the configuration and a deviation between the predicted value and the test value.

TABLE 4

| Predicted value | Test value | Deviation |
|---|---|---|
| 816.47 | 845.5 | 3.43% |

In this example, the deviation may be acceptable for design and target setting. It is to be understood that Table 4 is merely for illustration and is not intended for limitation.

In some embodiments, the predicting device 140 may transmit, to the computing device 130, a configuration and a corresponding test result of startup performance. In some embodiments, the predicting device 140 may also transmit, to the computing device 130, deviation associated with the test result for the configuration. The computing device 130 may decide to add the configuration and the corresponding test result into the learning set to update the model. In this way, more accurate prediction may be achieved.

In some embodiments, the learning set may be updated from release to release of a configuration of a communication device. For new release, some typical configuration test results may be picked as high weight. In this way, more accurate prediction may also be achieved.

The model according to embodiments of the present disclosure may be applied in any other suitable system startup performance prediction usages, as long as the set of factors which will impact the startup performance is updated or changed according to actual scenarios. It is to be understood that any other system startup performance prediction usages will also fall into the protect scope of the present disclosure.

### Example Implementation of Apparatus and Devices

Example embodiments of the present disclosure also provide the corresponding apparatus. In some embodiments, an apparatus (for example, the computing device 130) capable of performing the method 200 may comprise means for performing the respective steps of the method 200. The means may be implemented in any suitable form. For example, the means may be implemented in a circuitry or software module.

In some embodiments, the apparatus comprises: means for obtaining, at an electronic device, a set of configurations of the communication device and a set of test values of the startup performance of the communication device for the set of configurations; and means for constructing a model for startup performance predication by using a configuration in the set of configurations as an input and a corresponding test result in the set of test values as an output.

In some embodiments, a configuration in the set of configurations comprises a set of factors associated with the startup performance of the communication device. In some embodiments, the means for constructing the model comprises means for determining a set of parameters associated with the set of factors for the predication of the startup performance for the untested configuration.

In some embodiments, the set of factors in the configuration comprise at least one of hardware, software or topology for a component in the communication device. In some embodiments, the component comprises at least one of a baseband unit or a radio unit, and the set of factors comprises at least one of the following: the number or types of hardware in the baseband unit, the number or types of software in the baseband unit, the number or types of hardware in the radio unit, the number or types of software in the radio unit, the number of radio access technologies, or the number of cells.

In some embodiments, the apparatus may further comprise: means for obtaining a further set of configurations of the communication device and a further set of test values of startup performance of the communication device for the further set of configurations; and means for updating the model by using a configuration in the further set of configurations as an input and a corresponding test result in the further set of test values as an output.

In some embodiments, the communication device is an access network device, a core network device or a terminal device.

In some embodiments, an apparatus (for example, the predicting device 140) capable of performing the method 300 may comprise means for performing the respective steps of the method 300. The means may be implemented in any suitable form. For example, the means may be implemented in a circuitry or software module.

In some embodiments, the apparatus comprises: means for obtaining, at an electronic device, a configuration of the communication device to be tested; and means for determining a predicted value of startup performance of the communication device by using the configuration as an input of a model for startup performance predication.

In some embodiments, the configuration comprises a set of factors associated with the startup performance of the communication device. In some embodiments, the set of factors in the configuration comprise at least one of hardware, software or topology for a component in the communication device.

In some embodiments, the component comprises at least one of a baseband unit or a radio unit, and wherein the set of factors comprises at least one of the following: the number or types of hardware in the baseband unit, the number or types of software in the baseband unit, the number or types of hardware in the radio unit, the number or types of software in the radio unit, the number of radio access technologies, or the number of cells.

In some embodiments, the apparatus may further comprise: means for obtaining a test value of the startup performance of the communication device for the configuration; means for determining a deviation between the test value and the predicted value; and means for determining availability of the configuration of the communication device or availability of the model based on comparison between the deviation and a threshold deviation.

In some embodiments, the communication device is an access network device, a core network device or a terminal device.

FIG. 4 illustrates a simplified block diagram of an electronic device 400 that is suitable for implementing embodiments of the present disclosure. The device 400 may be used to implement the computing device 130 or the predicting device 140 of FIG. 1. As shown in FIG. 4, the device 400 may comprise a central processing unit (CPU) 401, which may perform various appropriate actions and processes according to computer program instructions stored in a read only memory (ROM) 402 or computer program instructions loaded from a storage unit 408 into a random access memory (RAM) 403. In the RAM 403, various programs and data required for the operation of device 400 may also be stored. CPU 401, ROM 402 and RAM 403 may be connected to each other through a bus 404. An input/output (I/O) interface 405 may also be connected to the bus 404.

A plurality of components in the device 400 may be connected to the I/O interface 405, for example, including: an input unit 406 such as a keyboard, mouse, etc.; an output unit 407 such as various types of displays, speakers, etc.; the storage unit 408 such as a magnetic disk, an optical disk, or the like; and a communication unit 409 such as a network card, a modem, a wireless communication transceiver, etc. The communication unit 409 allows the device 400 to exchange information or data with other devices through computer networks such as the Internet and/or various telecommunication networks.

The CPU 401 performs various methods and processes described above such as methods 200 and/or 300. For example, in some embodiments, methods 200 and/or 300 may be implemented as computer software programs that are tangibly contained in a machine-readable medium, such as the storage unit 408. In some embodiments, part or all of the computer program may be loaded and/or installed on the device 400 via the ROM 402 and/or the communication unit 409. When the computer program is loaded into the RAM 403 and executed by the CPU 401, one or more steps of methods 200 and/or 300 described above may be performed. Alternatively, in other embodiments, the CPU 401 may be configured to execute the methods 200 and/or 300 by any other suitable means (e.g., by means of firmware).

The present disclosure also provides at least one computer program product tangibly stored on a non-transitory computer readable storage medium. The computer program product includes computer-executable instructions, such as those included in program modules, being executed in a device on a target real or virtual processor, to carry out the methods 200 and/or 300 as described above with reference to FIGS. 2-3. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-27. (canceled)

28. An electronic device comprising:
at least one processor; and
at least one memory including computer program code,
the at least one memory and the computer program code configured to, with the at least one processor, cause the electronic device to:
obtain a set of configurations of a communication device and a set of test values of startup performance of the communication device for the set of configurations; and
construct a model for startup performance predication by using a configuration in the set of configurations as an input and a corresponding test result in the set of test values as an output.

29. The electronic device of claim 28, wherein a configuration in the set of configurations comprises a set of factors associated with the startup performance of the communication device, and wherein the electronic device is caused to construct the model by:
determining a set of parameters associated with the set of factors for the predication of the startup performance for the untested configuration.

30. The electronic device of claim 29, wherein the set of factors in the configuration comprise at least one of hardware, software or topology for a component in the communication device.

31. The electronic device of claim 30, wherein the component comprises at least one of a baseband unit or a radio unit, and wherein the set of factors comprises at least one of the following:
the number or types of hardware in the baseband unit,
the number or types of software in the baseband unit,
the number or types of hardware in the radio unit,
the number or types of software in the radio unit,
the number of radio access technologies, or
the number of cells.

32. The electronic device of claim 28, wherein the electronic device is further caused to:
obtain a further set of configurations of the communication device and a further set of test values of startup performance of the communication device for the further set of configurations; and
update the model by using a configuration in the further set of configurations as an input and a corresponding test result in the further set of test values as an output.

33. The electronic device of claim 28, wherein the communication device is an access network device, a core network device or a terminal device.

34. An electronic device comprising:
at least one processor; and
at least one memory including computer program code,
the at least one memory and the computer program code configured to, with the at least one processor, cause the electronic device to:
obtain a configuration of a communication device to be tested; and
determine a predicted value of startup performance of the communication device by using the configuration as an input of a model for startup performance predication.

35. The electronic device of claim 34, wherein the configuration comprises a set of factors associated with the startup performance of the communication device, and wherein the set of factors in the configuration comprise at least one of hardware, software or topology for a component in the communication device.

36. The electronic device of claim 34, wherein the electronic device is further caused to:
obtain a test value of the startup performance of the communication device for the configuration;
determine a deviation between the test value and the predicted value; and
determine availability of the configuration of the communication device or availability of the model based on comparison between the deviation and a threshold deviation.

37. A method for predicting startup performance of a communication device, comprising:
obtaining, at an electronic device, a set of configurations of the communication device and a set of test values of the startup performance of the communication device for the set of configurations; and
constructing a model for startup performance predication by using a configuration in the set of configurations as an input and a corresponding test result in the set of test values as an output.

38. The method of claim 37, wherein a configuration in the set of configurations comprises a set of factors associated with the startup performance of the communication device, and wherein constructing the model comprises:
determining a set of parameters associated with the set of factors for the predication of the startup performance for the untested configuration.

39. The method of claim 38, wherein the set of factors in the configuration comprise at least one of hardware, software or topology for a component in the communication device.

40. The method of claim 37, further comprising:
obtaining a further set of configurations of the communication device and a further set of test values of startup performance of the communication device for the further set of configurations; and
updating the model by using a configuration in the further set of configurations as an input and a corresponding test result in the further set of test values as an output.

41. A method for predicting startup performance of a communication device, comprising:
obtaining, at an electronic device, a configuration of the communication device to be tested; and
determining a predicted value of startup performance of the communication device by using the configuration as an input of a model for startup performance predication.

42. The method of claim 41, wherein the configuration comprises a set of factors associated with the startup performance of the communication device, and wherein the set of factors in the configuration comprise at least one of hardware, software or topology for a component in the communication device.
